(19) United States
(12) Patent Application Publication
(10) Pub. No.: US 2021/0010645 A1
(43) Pub. Date: Jan. 14, 2021

(54) ARTIFICIAL INTELLIGENCE DETECTION SYSTEM FOR DEEP-BURIED FUEL GAS PIPELINE LEAKAGE

(71) Applicants: ANHUI UNIVERSITY OF SCIENCE AND TECHNOLOGY, Huainan (CN); HEFEI INSTITUTE OF PUBLIC SAFETY, TSINGHUA UNIVERSITY, Anhui (CN)

(72) Inventors: Pingsong ZHANG, Huainan (CN); Binyang SUN, Huainan (CN); Hongyong YUAN, Huainan (CN); Sheng XUE, Huainan (CN); Liquan GUO, Huainan (CN); Ming FU, Huainan (CN); Xiongwu HU, Huainan (CN)

(21) Appl. No.: 16/923,696

(22) Filed: Jul. 8, 2020

(30) Foreign Application Priority Data
Jul. 9, 2019 (CN) 201910615940.4

(51) Int. Cl. F17D 5/06; F17D 5/00; G01M 3/00

(52) U.S. Cl. CPC F17D 5/06; G01K 11/32; G01M 3/002; F17D 5/005

(57) ABSTRACT

The present disclosure provides an artificial intelligence detection system for deep-buried fuel gas pipeline leakage, including a multi-field source information collecting system, a data processing and analyzing system, and a monitoring and warning system, wherein the multi-field source information collecting system includes a concentration field collecting subsystem, a temperature field collecting subsystem, and a geoelectric field collecting subsystem; the concentration field collecting subsystem collects concentration field data; the temperature field collecting subsystem collects temperature field data; the geoelectric field collecting subsystem collects geoelectric field data; the data processing and analyzing system receives the concentration field data, temperature field data and geoelectric field data, calculates variations of the respective data, compares the variations with corresponding variation thresholds, and determines whether to generate a warning signal; the monitoring and warning system alarms upon receipt of the warning signal generated by the data processing and analyzing system.

### TECHNICAL FIELD

The present disclosure relates to the field of fuel gas leak detection systems, in particular to an artificial intelligence detection system for deep-buried fuel gas pipeline leakage.

### BACKGROUND

At present, with the proposal of China's coal de-capacity policies, oil and gas resources have become an increasingly significant component of the national economy. However, the uneven distribution of oil and gas resources leads to their low utilization, which often requires long-distance, large-scale transportation. Pipelines have become a main means of oil and gas transportation due to many advantages. Existing fuel gas pipelines can generally be divided into two categories: one running overhead, and the other buried underground. For various reasons, pipeline leakage is inevitable. The leakage of overhead pipelines is mainly caused by defects in the body parts; other factors include exposure to the sun or rain. The leakage of underground pipelines is mainly caused by external factors, such as landslides, subsidence and subterranean river scouring.

Pipeline leakage detection has been studied extensively by Chinese and foreign researchers, and can generally be done in two ways: direct and indirect. Direct detection methods mostly use a leak-sensitive material as a sensing unit near the pipeline; when leakage occurs in the pipeline, the sensing unit interacts with the leak and outputs a piezoelectric signal, alerting the staff of the leakage. This method provides a high accuracy, but also has the disadvantages such as high cost and unsatisfying detection continuity, limiting its range of application. Other direct detection methods include manual visual inspection (low-cost, low-efficiency). Indirect detection methods infer and estimate the possibility of leakage by monitoring an operating parameter of the pipeline, such as concentration, pressure, rate of flow and temperature. Indirect detection methods include: mass balancing (high-cost but cannot accurately locate), negative pressure wave (simple and easy-to-use, but not suitable for small-scale leakage), pressure gradient (poor locating performance), pressure point analysis (poor locating performance), statistical methods (low-cost, poor locating performance), stress wave (poor locating performance), etc.

The methods above are limited by their own conditions and most have the problems such as difficulties in locating, making them unable to meet the needs of safe operation and management of fuel gas pipelines in current smart pipeline networks. To sum up, there is a lack of a fuel gas pipeline inspection system with a simple structure, appropriate design, convenient operability and good performance, which can effectively solve the problems in the existing fuel gas pipeline inspection systems that they cannot accurately locate the leak point, are only suitable for some situations, are slow in emergency response, and have difficulties in obtaining critical information. In view of this, mainly for deep-buried underground pipelines, the present disclosure provides an artificial intelligence inspection system and detection method for deep-buried fuel gas pipeline leakage.

### SUMMARY OF PARTICULAR EMBODIMENTS

An object of the present disclosure is to provide an artificial intelligence detection system for deep-buried fuel gas pipeline leakage, with a simple structure, appropriate design, convenient operability and good performance, which can effectively solve the problems in the existing fuel gas pipeline inspection systems that they cannot accurately locate the leak point, are only suitable for some situations, are slow in emergency response, and have difficulties in obtaining critical information.

In order to achieve the above object, the present disclosure adopts the following technical solutions.

An artificial intelligence detection system for deep-buried fuel gas pipeline leakage, including a multi-field source information collecting system, a data processing and analyzing system, and a monitoring and warning system, wherein:

the multi-field source information collecting system comprises a concentration field collecting subsystem, a temperature field collecting subsystem, and a geoelectric field collecting subsystem; the concentration field collecting subsystem is configured to collect a concentration field signal in a fuel gas pipeline region and obtain concentration field data; the temperature field collecting subsystem is configured to collect a temperature field signal in a fuel gas pipeline region and obtain temperature field data; the geoelectric field collecting subsystem is configured to collect a geoelectric field signal in a fuel gas pipeline region and obtain geoelectric field data;

the data processing and analyzing system is connected wirelessly to the respective subsystems of the multi-field source information collecting system via a wireless communication network, so that the subsystems transmit the concentration field data, temperature field data and geoelectric field data to the data processing and analyzing system respectively; according to the concentration field data, temperature field data and geoelectric field data, the data processing and analyzing system acquires a variation of the concentration field data, a variation of the temperature field data and a variation of the geoelectric field data; preset with a concentration field data variation threshold, a temperature field data variation threshold and a geoelectric field data variation threshold, the data processing and analyzing system compares the variation of the concentration field data, the variation of the temperature field data and the variation of the geoelectric field data with respective corresponding variation thresholds, and generates a warning signal when at least two of the variations exceeds their corresponding thresholds;

the monitoring and warning system is connected to the data processing and analyzing system, and configured to alarm upon receipt of the warning signal generated by the data processing and analyzing system.

In the artificial intelligence detection system for deep-buried fuel gas pipeline leakage, the concentration field collecting subsystem is a laser methane detecting instrument; the laser methane detecting instrument is connected wirelessly to the data processing and analyzing system; the laser methane detecting instrument emits laser light to a fuel gas pipeline region, the laser light being absorbed by a methane gas in the fuel gas pipeline region; the laser methane detecting instrument receives the returned changed laser light, calculates the concentration field data of the methane gas in the fuel gas pipeline region according to a variation of the laser light, and transmits the concentration field data to the data processing and analyzing system;

the data processing and analyzing system calculates a variation of the concentration field data between adjacent time points in continuous time according to the concentration field data.

In the artificial intelligence detection system for deep-buried fuel gas pipeline leakage, the temperature field collecting subsystem is an optical fiber distributed temperature measurement system; the optical fiber distributed temperature measurement system includes a host connected wirelessly to the data processing and analyzing system; the optical fiber distributed temperature measurement system includes a distributed temperature measurement optical fiber wound on a guide rod and transmitted by the guide rod to a fuel gas pipeline region; affected by the temperature of the fuel gas pipeline region, an internal light signal of the distributed temperature measurement optical fiber changes and the changed light signal is backscattered into the host of the optical fiber distributed temperature measurement system; the host calculates the temperature field data of the fuel gas pipeline region according to the changed light signal and transmits the temperature field data to the data processing and analyzing system;

the data processing and analyzing system calculates a variation of the temperature field data between adjacent time points in continuous time according to the temperature field data.

In the artificial intelligence detection system for deep-buried fuel gas pipeline leakage, the host of the optical fiber distributed temperature measurement system is preset with a temperature field data background value, the temperature field data background value being acquired from an ambient temperature of the fuel gas pipeline region collected on sited by the optical fiber distributed temperature measurement system; the host of the optical fiber distributed temperature measurement system removes the background value from the temperature field data measured from the fuel gas pipeline region, to obtain an effective temperature field data.

In the artificial intelligence detection system for deep-buried fuel gas pipeline leakage, the geoelectric field collecting subsystem is an electrical resistivity testing system; the electrical resistivity testing system comprises a digital resistivity meter integrated with a programmable electrode switcher, a communication cable and a plurality of electrode sensing units; the digital resistivity meter is connected wirelessly to the data processing and analyzing system; the digital resistivity meter is connected to the electrode sensing units via the communication cable; the digital resistivity meter supplies power to the electrode sensing units, the electrode sensing units interact with the fuel gas pipeline region and acquire an electrical signal, the electrical signal being transmitted via the communication cable to the digital resistivity meter; the digital resistivity meter acquires an apparent resistivity of the fuel gas pipeline region, infers a true resistivity of the fuel gas pipeline region based on the apparent resistivity, and transmits the true resistivity as the geoelectric field data to the data processing and analyzing system;

the data processing and analyzing system calculates a variation of the geoelectric field data between adjacent time points in continuous time according to the geoelectric field data.

The digital resistivity meter is integrated with the programmable electrode switcher in order to switch between electrode power supply modes. That is, the testing system includes multiple electrodes, with 1-2 electrodes being power supply electrodes, and the rest being measuring electrodes; each of the electrodes can be switched freely between power supply/measuring modes, and by the programmable electrode switcher internal switching is realized.

In the artificial intelligence detection system for deep-buried fuel gas pipeline leakage, the electrode sensing units are arranged at equal intervals in a circle, where the circle has a radius determined according to the range of the fuel gas pipeline region.

In the artificial intelligence detection system for deep-buried fuel gas pipeline leakage, the data processing and analyzing system is a remote upper computer; the remote upper computer comprises a database, a calculation module, a comparison module and a warning signal generating module; the concentration field data, temperature field data and geoelectric field data and the variation thresholds are stored in the database; the calculation module is configured to calculate a variation of the concentration field data, a variation of the temperature field data and a variation of the geoelectric field data between adjacent time points in continuous time; the comparison module is configured to compare the variation of the concentration field data, the variation of the temperature field data and the variation of the geoelectric field data with respective corresponding variation thresholds and obtain a comparison result; the warning signal generating module is configured to determine whether to generate a warning signal according to the comparison result.

In the artificial intelligence detection system for deep-buried fuel gas pipeline leakage, the monitoring and warning system comprises a display and an audible-visual alarming module; the display and the audible-visual alarming module are connected electrically to the remote upper computer respectively.

In the artificial intelligence detection system for deep-buried fuel gas pipeline leakage, a GPS positioning and navigation system, wherein the GPS positioning and navigation system is connected wirelessly to the data processing and analyzing system; the GPS positioning and navigation system is configured to collect GPS positioning data in the fuel gas pipeline region and transmit to the data processing and analyzing system.

In the artificial intelligence detection system for deep-buried fuel gas pipeline leakage, the multi-field source information collecting system, the GPS positioning and navigation system and the data processing and analyzing system form a wireless local area network based on 4G network, to realize wireless communication.

Compared with the prior art, the present disclosure may have the following advantages:

1. The present disclosure uses three physical fields, concentration field, temperature field and geoelectric field, to jointly test the leakage source in a deep-buried fuel gas pipeline, and provides a greatly improved detection accuracy of the abnormality leakage zone, as compared with the existing concentration based single field method.

2. The present disclosure combines a 4G network and a wireless local area network, which accelerates and facilitates information transmission, effectively increases emergency response speed and greatly shortens repair time.

3. The system of the present disclosure includes a built-in GPS positioning and navigation system, which can track the working path of an inspector in real time and thus enables immediate location of a leakage source as soon as the leakage source is found.

4. The concentration testing in the system of the present disclosure is not done in a conventional contact-based manner, but with an advanced laser testing technique, which broadens the range of application and provides a significantly higher detection efficiency. The sensing unit for temperature field testing includes a distributed temperature sensing optical fiber that combines sensing and transmission functions and is suitable for harsh environments, greatly improving survivability as compared with conventional sensors. The geoelectric field testing system is not arranged in a line, but in a circle with a variable radius, which is more convenient and faster to use.

### BRIEF DESCRIPTION OF THE DRAWINGS

FIG. 1 is a schematic diagram of a system of the present disclosure;

FIG. 2 is a schematic diagram of a concentration field collecting subsystem of the present disclosure;

FIG. 3 is a schematic diagram of a temperature field collecting subsystem of the present disclosure;

FIG. 4 is a schematic diagram of a geoelectric field collecting subsystem of the present disclosure.

### DETAILED DESCRIPTION OF PARTICULAR EMBODIMENTS

The present disclosure will be further described below in conjunction with the drawings and embodiments.

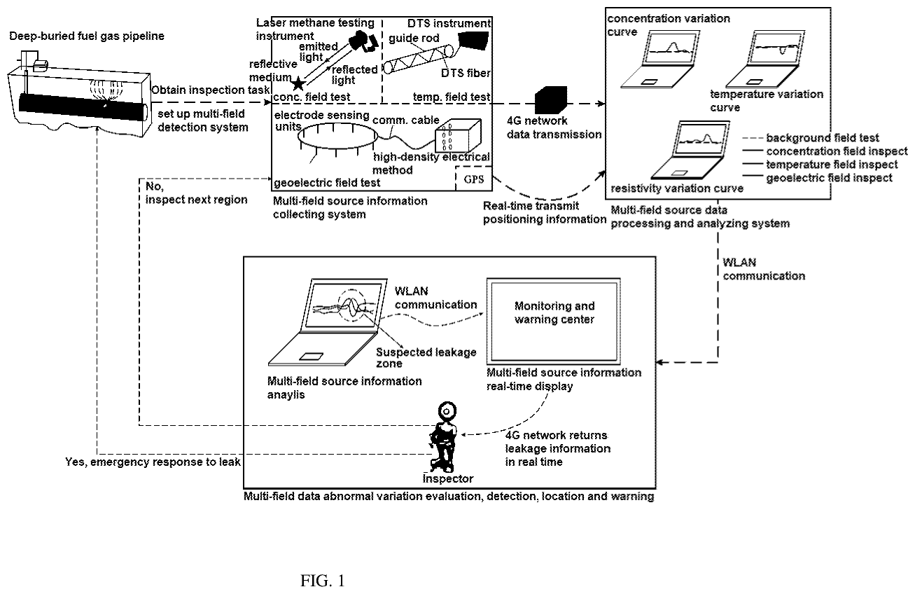

As shown in FIG. 1, an artificial intelligence detection system for deep-buried fuel gas pipeline leakage includes: a multi-field source information collecting system, a data processing and analyzing system, and a monitoring and warning system. The multi-field source information collecting system includes three collection subsystems, a concentration field collecting subsystem, a temperature field collecting subsystem and a geoelectric field collecting subsystem.

As shown in FIG. 2, the concentration field collecting subsystem is mainly based on a laser methane testing instrument, which is sensitive to methane gas. Mainly a tunable diode laser absorption spectroscopy technique is used. The concentration field collecting subsystem may include: 1—power source system: 1-1 charging unit, 1-2 power supply unit; 2—detection system: 2-1 laser light source module, 2-2 electronic module (i.e., light source driving module for driving the light source to operate), 2-3 laser emitting system, 2-4 laser receiving system; 3—signal processing system: 3-1 signal separation module, 3-2 signal processing module. Specifically, the charging unit 1-1 is connected to an external power grid and supplies power to the power supply unit 1-2; the power supply unit 1-2 supplies power to the electronic module 2-2; the electronic module 2-2 drives the light source module 2-1 for laser light emission; the laser emitting system 2-3 emits laser light to a fuel gas pipeline region; the fuel gas pipeline region returns laser light and the laser receiving system 2-4 receives the returned laser light; the laser receiving system 2-4 generates a signal and the signal is transmitted to the signal processing system 3; the signal separation module 3-1 of the signal processing system 3 separates off noise; finally, the signal processing module 3-2 processes and obtains concentration field data.

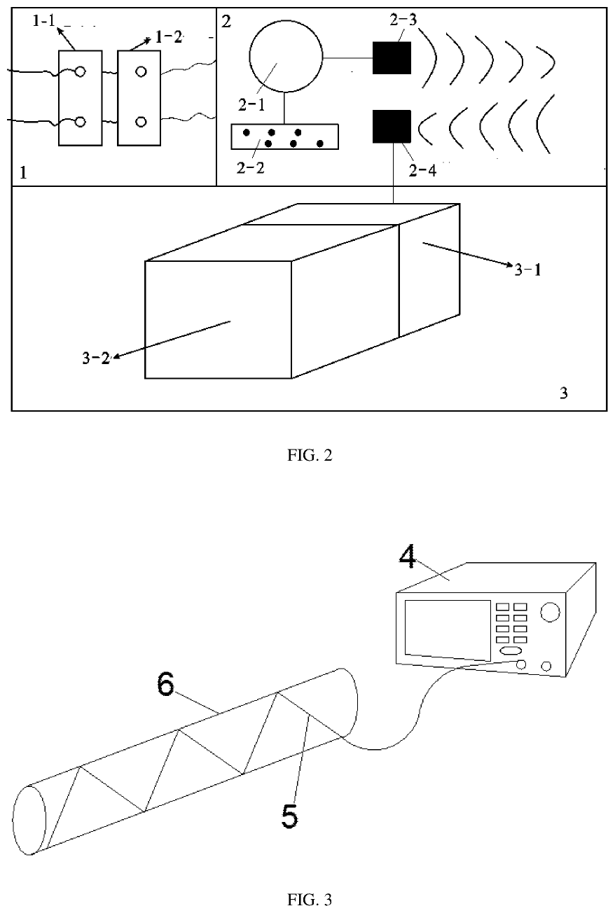

As shown in FIG. 3, the temperature field collecting subsystem is an optical fiber distributed temperature measurement system, which mainly includes: 4—optical fiber distributed temperature testing instrument, 5—distributed temperature measurement optical fiber, and 6—automatic lifting guide rod. The optical fiber distributed temperature testing instrument is responsible for exciting a light source signal, which enters the distributed temperature measurement optical fiber 5 via a modulator-demodulator; the distributed temperature measurement optical fiber 5 is spirally wound on the outside of the automatic lifting guide rod 6; the automatic lifting guide rod 6 transmits the distributed temperature measurement optical fiber to the fuel gas pipeline region, which is a detection target region; the distributed temperature measurement optical fiber 5 senses the temperature of the target region, which causes its internal light source signal to change; the changed light signal is backscattered and enters the host of the optical fiber distributed temperature testing instrument 4; the host calculates and obtains temperature field data of the detection target region.

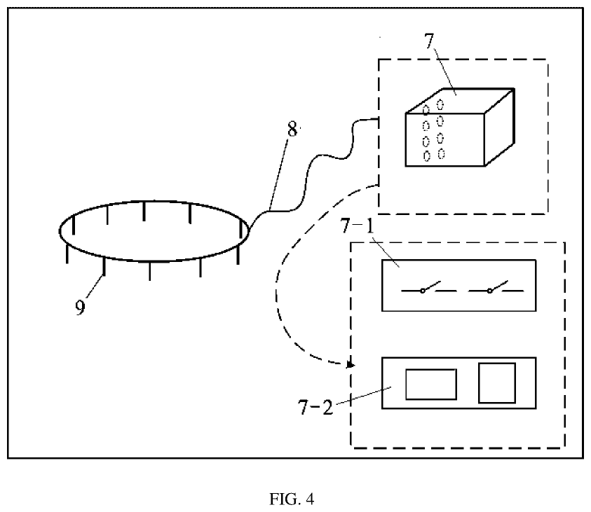

As shown in FIG. 4, the geoelectric field collecting subsystem is an electrical resistivity testing system based on a high-density electrical method instrument, which mainly includes: 7—multi-channel collection host, 8—communication cable, and 9—multi-channel collection sensing unit. Specifically, the multi-channel collection host generally includes eight channels, and is made up of a digital resistivity meter 7-2 and an integrated programmable electrode switcher 7-1; the collection sensing unit 9 is made up of sixty-four electrode sensing units, and the sixty-four electrode sensing units are arranged at equal intervals in a circle, where the circle has a radius determined according to the range of the exploration target region, ranging from 0.5 m to 3 m. The digital resistivity meter 7-2 supplies power to the electrode sensing units; the electrode sensing units collect electrical signals and transmit to the digital resistivity meter 7-2 via the communication cable 8; the digital resistivity meter 7-2 obtains electrical resistivity data, which is used as geoelectric field data.

The digital resistivity meter 7-2 is integrated with the programmable electrode switcher 7-1 in order to switch between electrode power supply modes. That is, the testing system includes multiple electrodes, with 1-2 electrode sensing units being power supply electrodes, and the rest being measuring electrodes; each of the electrodes can be switched freely between power supply/measuring modes, and internal switching can be realized by the programmable electrode switcher 7-1.

The system uses the laser methane testing instrument, optical fiber distributed temperature testing instrument and high-density electrical method instrument to test the concentration field, temperature field and geoelectric field respectively.

For concentration field testing: the laser methane testing instrument emits laser light; the laser light passes through a methane target when a natural gas leak occurs and is absorbed by the methane gas; laser light after absorption is reflected by objects and returned to the testing instrument; an internal component of the instrument calculates the concentration of methane in the target region.

For temperature field testing: the distributed temperature measurement optical fiber combines sensing and transmission functions, i.e., it is both a sensor and a signal transmitter. According to detection needs, collection parameters are configured at the optical fiber distributed temperature testing instrument, to achieve testing effect. For subsequent dynamic analysis and comparison charting in relation to temperature, a set of initial background values are collected as a reference. Due to the large differences between temperatures in the morning, at noon and in the afternoon of the day in different seasons, in order to ensure the validity of the collected temperature data, multiple sets of temperature field background values are collected as the reference, including: a set of background values collected in the morning, at noon and in the afternoon for each of spring, summer, autumn and winter.

For geoelectric field data collection: the conventional electrical resistivity testing system is changed, where the electrodes are no longer arranged in a conventional linear manner, instead, the electrodes are arranged in a circle, with a detection system radius determined according to actual needs. When the detection system has been positioned above the target region, collection parameters (power supply voltage, power supply mode, power supply time, sampling frequency, etc.) are set according to actual needs; then the system is powered on and detection is performed, to obtain resistivity values in different ranges.

In addition, a built-in GPS positioning and navigation system is included, which can track the inspection paths of inspectors in real time and accurately locate the detection points.

In the present disclosure, the concentration field testing instrument is a laser methane testing instrument, which can directly acquire the concentration value of the fuel gas in the measured region. The emitted laser light passes through the gas to be tested, and laser light after absorption is reflected by objects and returned to the testing instrument; the concentration value of the fuel gas in the target region can be calculated by an internal component of the testing instrument, which is recorded as P_{detect}.

In the present disclosure, the data collected by the temperature field testing instrument is Brillouin frequency shift, and Brillouin frequency shift is positively correlated with temperature. The temperature value can be obtained according to Equation (1):

v_{B}(T)=C_{T}·(T−T₀) (1)

where v_{B} denotes the Brillouin spectrum; C_{T} denotes the ratio of Brillouin frequency shift to temperature, i.e., the temperature coefficient; T denotes the measured temperature, and T₀ is an initial temperature value, i.e., the background value.

Generally, temperature calibration of the distributed temperature measurement optical fiber is performed in advance, to obtain C_{T}. The temperature calibration method includes: immersing a length of the optical fiber in a constant temperature water bath; increasing the temperature from an initial 10° C., to 100° C. at 10° C. intervals, to obtain a Brillouin frequency shift value at each temperature. Each testing lasts 20 minutes and includes three measurements, the average of which is used as the final value. Finally, a temperature calibration curve can be obtained and C_{T} can be obtained by a linear fitting of the temperature calibration curve.

Data conversion and analysis. Analysis software provided along with the instrument can be used to convert a source file in (.sat) format into (.xls) format and remove abnormal data. Then, the temperature value T can be obtained by using Equation (1) based on C_{T}. Finally, Origin can be used to perform corresponding processing on the temperature data and draw a temperature curve trend.

Temperature variations at respective points along the optical fiber can be determined according to Equation (1). When a temperature abnormality occurs at a point in an upper region of the deep-buried pipeline, the distributed temperature measurement optical fiber can detect the temperature abnormality zone.

In the present disclosure, the geoelectric field testing instrument can directly acquire electrical current values in the target region, and required parameters can be calculated according to the following process, including: (1) importing raw data collected by the instrument into WBD conversion and analysis software, inputting electrode coordinates, calculating corresponding apparent resistivities, removing abnormal apparent resistivity values in the entire section, and finally exporting apparent resistivity data of the corresponding device; (2) opening apparent resistivity data in (.dat) format with Surfer mapping software, performing basic processing such as gridding the data according to the nearest neighbor method, resizing the grid file and filtering out abnormal data, selecting a filter according to actual needs to filter and blank the data, and obtaining an apparent resistivity map of the corresponding device.

Apparent resistivity values at respective points in the target region are collected on site. In order to obtain a map reflecting true resistivity distribution in the testing region, inferring is performed based on the measured data; the inferring can be done using AGI software. The basic process of the data processing mainly involves three major functional modules: a preprocessing module, a data inferring processing module, and a data result mapping processing module. Finally, a true resistivity value ρ_{detect} in the target range is obtained.

The data processing and analyzing system of the present disclosure evaluates abnormal variations in the multi-field data of the deep-buried fuel gas pipeline region: based on multi-field data variation characteristics from fuel gas concentration field, temperature field and geoelectric field in the detection target region, it analyzes and determines the contents of natural gas in an upper part of the fuel gas pipeline. The data collected by the three types of equipment units is transmitted to the data processing and analyzing system via 4G network transmission. The data processing and analyzing system, based on relevant information such as the gas concentration, temperature and resistivity, and based on thresholds from previous experience, determines an abnormality zone when measured multi-field data changes significantly in comparison with the background value and exceeds the threshold, and sends a warning signal to the monitoring and warning system. The data processing and analyzing system may also quantitatively evaluate the possibility of fuel gas pipeline leakage according to the magnitude of the change of the abnormal value.

Specific embodiments described herein are for illustrative purposes only and shall not be construed as limiting the scope of the invention. Any modification or change made by those skilled in the art to the technical solutions of the present disclosure without departing from the idea of the invention shall fall within the scope of the invention. The scope claimed by the present invention is defined by the appended claims.

1. An artificial intelligence detection system for deep-buried fuel gas pipeline leakage, comprising a multi-field source information collecting system, a data processing and analyzing system, and a monitoring and warning system, wherein:
the multi-field source information collecting system comprises a concentration field collecting subsystem, a temperature field collecting subsystem, and a geoelectric field collecting subsystem; wherein:
the concentration field collecting subsystem is configured to collect a concentration field signal in a fuel gas pipeline region and obtain concentration field data;
the temperature field collecting subsystem is configured to collect a temperature field signal in a fuel gas pipeline region and obtain temperature field data; and
the geoelectric field collecting subsystem is configured to collect a geoelectric field signal in a fuel gas pipeline region and obtain geoelectric field data;
the data processing and analyzing system is connected wirelessly to the respective subsystems of the multi-field source information collecting system via a wireless communication network, so that the subsystems transmit the concentration field data, temperature field data and geoelectric field data to the data processing and analyzing system respectively; wherein:
according to the concentration field data, temperature field data and geoelectric field data, the data processing and analyzing system acquires a variation of the concentration field data, a variation of the temperature field data and a variation of the geoelectric field data;
preset with a concentration field data variation threshold, a temperature field data variation threshold and a geoelectric field data variation threshold, the data processing and analyzing system compares the variation of the concentration field data, the variation of the temperature field data and the variation of the geoelectric field data with respective corresponding variation thresholds, and generates a warning signal when at least two of the variations exceeds their corresponding thresholds; and
the monitoring and warning system is connected to the data processing and analyzing system, and configured to alarm upon receipt of the warning signal generated by the data processing and analyzing system.

2. The artificial intelligence detection system for deep-buried fuel gas pipeline leakage according to claim 1, wherein:
the concentration field collecting subsystem is a laser methane detecting instrument;
the laser methane detecting instrument is connected wirelessly to the data processing and analyzing system;
the laser methane detecting instrument emits laser light to a fuel gas pipeline region, the laser light being absorbed by a methane gas in the fuel gas pipeline region;
the laser methane detecting instrument receives the returned changed laser light, calculates the concentration field data of the methane gas in the fuel gas pipeline region according to a variation of the laser light, and transmits the concentration field data to the data processing and analyzing system; and
the data processing and analyzing system calculates a variation of the concentration field data between adjacent time points in continuous time according to the concentration field data.

3. The artificial intelligence detection system for deep-buried fuel gas pipeline leakage according to claim 1, wherein:
the temperature field collecting subsystem is an optical fiber distributed temperature measurement system;
the optical fiber distributed temperature measurement system includes a host connected wirelessly to the data processing and analyzing system;
the optical fiber distributed temperature measurement system includes a distributed temperature measurement optical fiber wound on a guide rod and transmitted by the guide rod to a fuel gas pipeline region;
affected by the temperature of the fuel gas pipeline region, an internal light signal of the distributed temperature measurement optical fiber changes and the changed light signal is backscattered into the host of the optical fiber distributed temperature measurement system;
the host calculates the temperature field data of the fuel gas pipeline region according to the changed light signal and transmits the temperature field data to the data processing and analyzing system; and
the data processing and analyzing system calculates a variation of the temperature field data between adjacent time points in continuous time according to the temperature field data.

4. The artificial intelligence detection system for deep-buried fuel gas pipeline leakage according to claim 3, wherein:
the host of the optical fiber distributed temperature measurement system is preset with a temperature field data background value, the temperature field data background value being acquired from an ambient temperature of the fuel gas pipeline region collected on sited by the optical fiber distributed temperature measurement system; and
the host of the optical fiber distributed temperature measurement system removes the background value from the temperature field data measured from the fuel gas pipeline region, to obtain an effective temperature field data.

5. The artificial intelligence detection system for deep-buried fuel gas pipeline leakage according to claim 1, wherein:
the geoelectric field collecting subsystem is an electrical resistivity testing system;
the electrical resistivity testing system comprises a digital resistivity meter integrated with a programmable electrode switcher, a communication cable and a plurality of electrode sensing units;
the digital resistivity meter is connected wirelessly to the data processing and analyzing system;
the digital resistivity meter is connected to the electrode sensing units via the communication cable;
the digital resistivity meter supplies power to the electrode sensing units, the electrode sensing units interact with the fuel gas pipeline region and acquire an electrical signal, the electrical signal being transmitted via the communication cable to the digital resistivity meter;
the digital resistivity meter acquires an apparent resistivity of the fuel gas pipeline region, infers a true resistivity of the fuel gas pipeline region based on the apparent resistivity, and transmits the true resistivity as the geoelectric field data to the data processing and analyzing system; and
the data processing and analyzing system calculates a variation of the geoelectric field data between adjacent time points in continuous time according to the geoelectric field data.

6. The artificial intelligence detection system for deep-buried fuel gas pipeline leakage according to claim 5, wherein the electrode sensing units are arranged at equal intervals in a circle, where the circle has a radius determined according to the range of the fuel gas pipeline region.

7. The artificial intelligence detection system for deep-buried fuel gas pipeline leakage according to claim 1, wherein:
the data processing and analyzing system is a remote upper computer; the remote upper computer comprises a database, a calculation module, a comparison module and a warning signal generating module;
the concentration field data, temperature field data and geoelectric field data and the variation thresholds are stored in the database;
the calculation module is configured to calculate a variation of the concentration field data, a variation of the temperature field data and a variation of the geoelectric field data between adjacent time points in continuous time;
the comparison module is configured to compare the variation of the concentration field data, the variation of the temperature field data and the variation of the geoelectric field data with respective corresponding variation thresholds and obtain a comparison result; and
the warning signal generating module is configured to determine whether to generate a warning signal according to the comparison result.

8. The artificial intelligence detection system for deep-buried fuel gas pipeline leakage according to claim 7, wherein the monitoring and warning system comprises a display and an audible-visual alarming module; and the display and the audible-visual alarming module are connected electrically to the remote upper computer respectively.

9. The artificial intelligence detection system for deep-buried fuel gas pipeline leakage according to claim 1, further comprising a GPS positioning and navigation system, wherein:
the GPS positioning and navigation system is connected wirelessly to the data processing and analyzing system; and
the GPS positioning and navigation system is configured to collect GPS positioning data in the fuel gas pipeline region and transmit to the data processing and analyzing system.

10. The artificial intelligence detection system for deep-buried fuel gas pipeline leakage according to claim 1, wherein the multi-field source information collecting system, the GPS positioning and navigation system and the data processing and analyzing system form a wireless local area network based on a 4G network, to realize wireless communication.

11. The artificial intelligence detection system for deep-buried fuel gas pipeline leakage according to claim 2, wherein the multi-field source information collecting system, the GPS positioning and navigation system and the data processing and analyzing system form a wireless local area network based on a 4G network, to realize wireless communication.

12. The artificial intelligence detection system for deep-buried fuel gas pipeline leakage according to claim 3, wherein the multi-field source information collecting system, the GPS positioning and navigation system and the data processing and analyzing system form a wireless local area network based on a 4G network, to realize wireless communication.

13. The artificial intelligence detection system for deep-buried fuel gas pipeline leakage according to claim 4, wherein the multi-field source information collecting system, the GPS positioning and navigation system and the data processing and analyzing system form a wireless local area network based on a 4G network, to realize wireless communication.

14. The artificial intelligence detection system for deep-buried fuel gas pipeline leakage according to claim 5, wherein the multi-field source information collecting system, the GPS positioning and navigation system and the data processing and analyzing system form a wireless local area network based on a 4G network, to realize wireless communication.

15. The artificial intelligence detection system for deep-buried fuel gas pipeline leakage according to claim 6, wherein the multi-field source information collecting system, the GPS positioning and navigation system and the data processing and analyzing system form a wireless local area network based on a 4G network, to realize wireless communication.

16. The artificial intelligence detection system for deep-buried fuel gas pipeline leakage according to claim 7, wherein the multi-field source information collecting system, the GPS positioning and navigation system and the data processing and analyzing system form a wireless local area network based on a 4G network, to realize wireless communication.

17. The artificial intelligence detection system for deep-buried fuel gas pipeline leakage according to claim 8, wherein the multi-field source information collecting system, the GPS positioning and navigation system and the data processing and analyzing system form a wireless local area network based on a 4G network, to realize wireless communication.

18. The artificial intelligence detection system for deep-buried fuel gas pipeline leakage according to claim 9, wherein the multi-field source information collecting system, the GPS positioning and navigation system and the data processing and analyzing system form a wireless local area network based on a 4G network, to realize wireless communication.
